(19) United States
(12) Patent Application Publication
(10) Pub. No.: US 2015/0365603 A1
(43) Pub. Date: Dec. 17, 2015

(54) CAMERA SYSTEM FOR A VEHICLE, METHOD AND DEVICE FOR CONTROLLING AN IMAGE AREA OF AN IMAGE FROM A VEHICLE CAMERA FOR A VEHICLE

(71) Applicant: ROBERT BOSCH GMBH, Stuttgart (DE)

(72) Inventors: Anja WAHL, Markgroeningen (DE); Matthias KLEWS, Tuebingen (DE); Markus LEMEJDA, Ludwigsburg (DE)

(21) Appl. No.: 14/764,457

(22) PCT Filed: Jan. 28, 2014
(86) PCT No.: PCT/EP2014/051644

§ 371 Date: Jul. 29, 2015

(30) Foreign Application Priority Data
Jan. 29, 2013 (DE) 10 2013 201 379.5

(51) Int. Cl. H04N 5/232; G06T 7/00; G06K 9/52; B60R 1/00; G06K 9/00

(52) U.S. Cl. CPC H04N 5/23296; B60R 1/00; G06K 9/00798; G06K 9/52; G06T 7/0042; H04N 5/23222

(57) ABSTRACT

A method is provided for controlling an image area of an image from a vehicle camera for a vehicle. The method includes a step of ascertaining positional information, which represents a road position of the vehicle relative to a road section on which the vehicle is traveling, using vehicle sensor data of the vehicle. In addition, method includes a step of generating a control signal for controlling the image area of the image from the vehicle camera, the generating utilizing the positional information.

### FIELD OF THE INVENTION

The present invention relates to a method for controlling an image area of an image from a vehicle camera for a vehicle and to a device for controlling an image area of an image from a vehicle camera for a vehicle; it also relates to a camera system for a vehicle and to a corresponding computer program product.

### BACKGROUND INFORMATION

Images from vehicle cameras, for example, especially images from forward-looking vehicle cameras, are frequently used for driver assistance systems. For instance, driver assistance systems can use these camera images to supply warning or assisting functionalities as well as comfort functionalities.

### SUMMARY

Against this background, an improved method for controlling an image area of an image from a vehicle camera for a vehicle, an improved device for controlling an image area of an image from a vehicle camera for a vehicle, an improved camera system for a vehicle, and an improved computer program product according to the independent claims are provided. Advantageous refinements derive from the respective dependent claims and from the following description.

According to specific embodiments of the present invention, an image area control, which is adaptable to a road position of a vehicle, or a field-of-view control for a vehicle camera is able to be provided. According to specific developments of the present invention, in particular a camera system or a camera featuring field-of-vision control, for instance is able to be made available to motorized two-wheeled vehicles or the like. More specifically, sensors are able to detect a current driving state of the vehicle, which can then be processed in a control unit, for example, so that an alignment or an orientation of the vehicle in space is able to be ascertained and the further course of the trajectory of the vehicle can be inferred. A field of view of the camera can be adjusted accordingly, or recorded camera images may be adapted or transformed.

In particular if a camera system is installed or is able to be installed in the vehicle, specific embodiments of the present invention advantageously make it possible to eliminate an influence of own vehicle movements, especially rolling, from a camera image of a vehicle camera. Also, a forward-looking visual guidance of the camera system, which is adapted to a subsequent trajectory of the vehicle, is advantageously able to be provided. As a result, it is possible to detect the vehicle environment in a manner that is specific to the driving situation. Specific embodiments of the present invention are advantageous and suitable both for motorized two-wheeled vehicles, whose own vehicle movements are larger in comparison with two-track vehicles, and for other road vehicles. In comparison with two-track vehicles, larger own movements, especially roll angles, may typically occur in motorized two-wheeled vehicles. According to specific embodiments of the present invention, a viewing direction of the vehicle camera is advantageously able to be unlinked from a rigid coupling to a position or orientation of the vehicle. In many driving situations a road region in which travel will actually occur in the further course is detectable to the fullest extent possible in camera images of the vehicle camera. The data acquired by the camera can therefore be more meaningful and reliable than the data provided without a position-adapted camera image control.

Regulation and driver assistance systems that record an environment of the vehicle with the aid of vehicle cameras have found their way into motor vehicles in ever increasing numbers. Such assistance systems may be used both to improve the driving comfort and to increase the active and passive safety. In the area of driving comfort, assistance systems are realizable which optically record a road profile and adapt active body structures in an optimal manner even before interference by the road is introduced into a suspension system via the ground contact. For the area of active and passive safety, camera systems are available which detect zones of a vehicle environment that are difficult for a driver to observe, and which can then be displayed on a display by these systems. In addition, camera systems are conceivable which are able to detect potential dangers in the environment of the vehicle, such as stationary or moving obstacles, straying from the road, etc., and can then either point these dangers out to the driver either by warning signals or even trigger automatic reactions of installed actuators, such as brakes, steering, etc. In conjunction with such assistance systems, specific embodiments of the present invention, especially specific embodiments which include position-adapted camera image control, are able to supply advantageous camera images or enable the recording of advantageous camera images, which can form the basis for reliable functioning of the assistance system.

A method for controlling an image area of an image from a vehicle camera for a vehicle has the following steps:

Ascertaining positional information, which represents a road position of the vehicle relative to a road section on which the vehicle is traveling, using vehicle sensor data of the vehicle; and

Generating a control signal for controlling the image area of the image from the vehicle camera, the generation utilizing the positional information.

The vehicle may be a motor vehicle, especially a road-bound motor vehicle such as a two-wheeled vehicle, a passenger car, a truck or some other commercial vehicle. The vehicle camera can be installed in or on the vehicle. For example, image data from the vehicle camera may also be provided to at least a driver assistance system and/or other image-based functionalities or applications.

Prior to or following the execution of the control method, an image can be recorded with the aid of the vehicle camera.

According to one specific embodiment, in the step of ascertaining, an angle of inclination of the vehicle relative to the road section may be ascertained as positional information with the aid of inertial sensor data of the vehicle. The angle of inclination may represent a yaw angle, a pitch angle, and/or a roll angle of the vehicle relative to the road section. As a minimum, the angle of inclination may therefore be related to an axis of rotation of the vehicle. In other words, it is possible to determine at least an angle of inclination of the vehicle relative to the road section. A specific embodiment of this type offers the advantage that such positional information constituting an angle of inclination is able to represent the road position of the vehicle in a precise and applicable manner and thereby allows the reliable generation of the control signal and the precise control the image area of the image.

In addition, in the step of ascertaining, a trajectory of the vehicle relative to the road section may be determined as positional information, using inertial sensor data and additional vehicle sensor data for inferring a driven curve radius of the vehicle. The trajectory may represent a course of the vehicle on a road section that adjoins the driven road section. Inertial sensors can be used for recording a position or orientation of the vehicle. The inertial sensors are able to provide detected translatory accelerations in at least one translatory degree of freedom and/or detected angular rates in at least one rotatory degree of freedom. By time integration, for example, these variables may be used for determining yaw rates, pitch angles and roll angles of the vehicle, in particular. The further vehicle sensor data can include a vehicle speed, a steering angle and/or the like. Using the further vehicle sensor data, the driven curve radius is able to be determined in conjunction with the inertial sensor data. Such a specific embodiment has the advantage that positional information of this type, which represents a vehicle trajectory, is also able to reproduce the road position of the vehicle in a precise and applicable manner, so that the control signal can be generated in an even more reliable manner and the image region of the image be controlled even more precisely.

Furthermore, in the step of generating, the control signal

may include an image compensation parameter for selecting an image area of an image recorded with the aid of the vehicle camera as a function of the positional information, for control of the image area of the image. In particular, for control of the image area, the control signal with the image compensation parameter may be developed to induce a selection of an image area which images a region of the vehicle environment that corresponds to the trajectory of the vehicle. The selected image area can represent at least a partial area of the image. The selected image area may be made available for subsequent processing steps and/or image-based functionalities. Such a specific embodiment offers the advantage that a relevant image area is ascertained as a function of the road position or the trajectory of the vehicle, so that a meaningful image having an advantageously controlled image area can be made available to subsequent processing steps and/or image-based functionalities.

In the step of generating, the control signal may also include a camera compensation parameter for adjusting a field of view of the vehicle camera as a function of the positional information for recording the image, in order to control the image area of the image. In particular, the control signal including the camera compensation parameter may be designed to induce an adjustment of the field of view of the vehicle camera for control of the image area by moving the vehicle camera with the aid of the control signal, in order to then be able to record an image that includes the controlled image area. Such a specific embodiment is advantageous insofar as an image is recordable which includes a relevant image area as a function of the road position or trajectory of the vehicle, so that subsequent processing steps and/or image-based functionalities can be supplied with a meaningful image that includes an advantageously controlled image area.

A device for controlling an image area of an image from a vehicle camera for a vehicle has the following features:

A device for ascertaining positional information, which represents a road position of the vehicle relative to a road section on which the vehicle is traveling, utilizing vehicle sensor data of the vehicle; and

A device for generating a control signal for controlling the image area of the image from the vehicle camera, the generation being performed utilizing the positional information.

The control device may be part of the vehicle camera or part of a control unit provided separately from the vehicle camera, or a similar device. In the case at hand, a device may also be an electrical device or a control unit, which processes sensor data and outputs control signals as a function thereof The device may include an interface developed in the form of hardware and/or software. In a hardware implementation, the interfaces may be part of a so-called system ASIC, for instance, which encompasses a wide variety of functionalities of the device. However, it is also possible that the interfaces are separate, integrated circuits or are at least partially made up of discrete components. In a software development, the interfaces may be software modules which, for example, are provided on a microcontroller in addition to other software modules.

The control device may be set up to execute or implement the steps of an aforementioned control method. In particular, the device may include apparatuses which are set up to carry out one step of one of the above-mentioned method in each case. This embodiment variant of the present invention in the form of a device may likewise be used to rapidly and efficiently achieve the objective on which the present invention is based.

An especially advantageous camera system for a vehicle has the following features:

A vehicle camera; and

a specific embodiment of the aforementioned device for controlling an image area of an image from the vehicle camera.

One specific embodiment of the aforementioned control device may advantageously be used in conjunction with the camera system. Also, one specific embodiment of the aforementioned control method may advantageously be developed in conjunction with the camera system in order to control an image area of an image from the vehicle camera.

According to one specific embodiment, the vehicle camera may be equipped with a wide angle lens. For control of the image area of the image, the control signal generated with the aid of the device may have an image compensation parameter for selecting an image area of an image recorded with the aid of the vehicle camera as a function of the positional information. In particular, for control of the image area, the control signal with the image compensation parameter may be developed to induce a selection of an image area that corresponds to the trajectory of the vehicle. The selected image area may represent at least a partial area of the image recorded with the aid of the wide angle lens. Such a specific embodiment offers the advantage that the camera system is suitable also for a permanently or immovably installed camera and thus can be provided for the vehicle in a simple and cost-effective manner.

A mounting device for mounting the vehicle camera on the vehicle in a manner that allows swivel movements may be provided as well. For control of the image area of the image, the control signal generated with the aid of the device may include a camera compensation parameter for adjusting a field of view of the vehicle camera in order to record the image as a function of the positional information with the aid of the mounting device. The mounting device may be designed to move or swivel the vehicle camera with the aid of the control signal. For control of the image area, the control signal with the camera compensation parameter in particular may be designed to induce an adjustment of the field of view of the vehicle camera by moving the vehicle camera with the aid of the control signal, so that an image that includes the controlled image area can then be recorded. Such a specific embodiment offers the advantage that a position-adapted

camera-image control is able to be achieved by a movably suspended vehicle camera.

Also advantageous is a computer program product having program code stored on a machine-readable carrier such as a semiconductor memory, a hard-disk memory or an optical memory, and which is used for carrying out the aforementioned method when the program is executed on a computer or a device.

### BRIEF DESCRIPTION OF THE DRAWINGS

FIG. 1 shows a schematic illustration of a vehicle having a camera system according to an exemplary embodiment of the present invention.

FIG. 2 shows a schematic illustration of a motorcycle having a camera system according to an exemplary embodiment of the present invention.

FIG. 3 shows a flow chart of a control method according to an exemplary embodiment of the present invention.

FIGS. 4 and 5 show flow charts of methods for providing according to specific embodiments of the present invention.

### DETAILED DESCRIPTION

In the following description of preferred exemplary embodiments of the present invention, identical or similar reference symbols are used for similarly acting elements shown in the various figures, and a repeated description of these elements has been omitted.

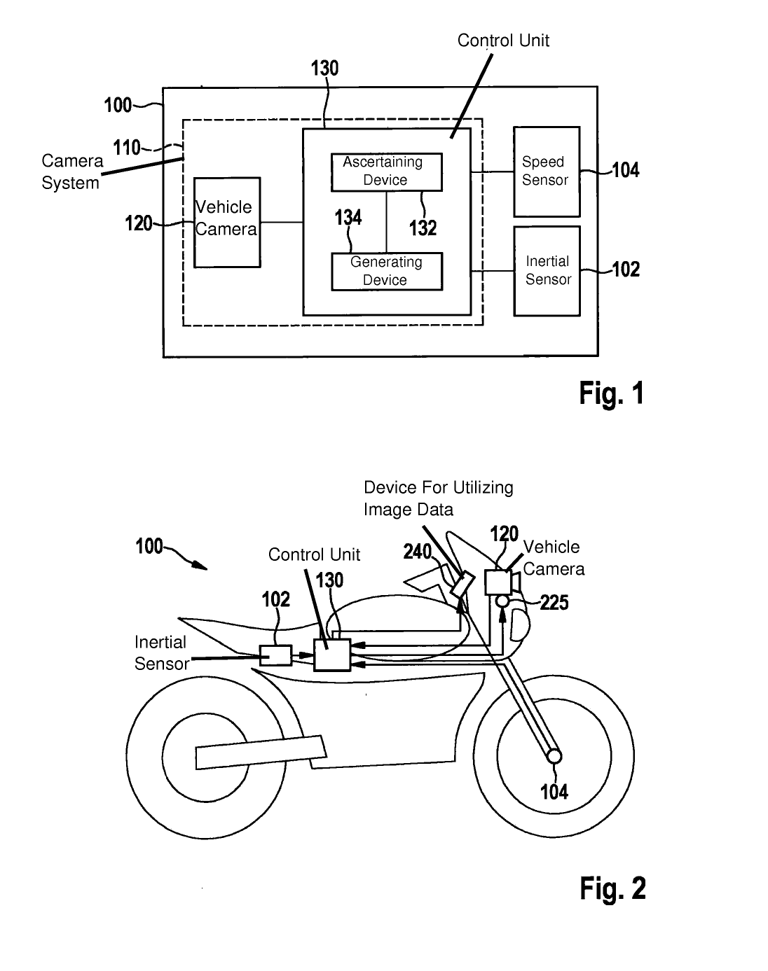

FIG. 1 shows a schematic representation of a vehicle 100 having a camera system according to an exemplary embodiment of the present invention. Vehicle 100, for instance, is equipped with an inertial sensor 102 and a speed sensor 104 as vehicle sensors, as well as a camera system 110. For example, speed sensor 104 can be developed on the basis of a wheel-speed sensor for estimating the vehicle speed. Camera system 110 is disposed inside vehicle 100. Camera system 110 includes a vehicle camera 120 and a control unit 130 or a device for controlling an image area of an image from vehicle camera 120. Control unit 130 includes an ascertaining device 132 and a generating device 134.

Inertial sensor 102 is connected to control unit 130 by a communications interface, e.g., an electrical line, a wireless connection, or the like. Inertial sensor 102 is developed to supply inertial sensor data. The inertial sensor in particular is designed to supply detected translatory accelerations of vehicle 100 in at least one translatory degree of freedom, and/or to supply detected angular rates of a rotary motion of vehicle 100 in at least one rotatory degree of freedom. Speed sensor 104 is connected to control unit 130 by a communications interface, e.g., an electrical line, a wireless connection, or the like. Speed sensor 104 is designed to supply speed data of a speed of vehicle 100.

Vehicle camera 120 of camera system 110 is developed to record an image of a vehicle environment of vehicle 100 and to generate image data representing the image of the vehicle environment of vehicle 100. Vehicle camera 120 is connected to control unit 130 by a communications interface, e.g., an electrical line, a wireless connection, or the like. Vehicle camera 120 supplies the image data to control unit 130. Although it is not shown in FIG. 1, vehicle camera 120 is furthermore developed to supply the image data to further vehicle systems, e.g., driver assistance systems or the like.

Control unit 130 is designed to receive or read in from vehicle camera 120 the image data representing the image of the vehicle environment of vehicle 100, and to receive or read in as vehicle sensor data the speed data from speed sensor 104 and the inertial sensor data from inertial sensor 102. Control unit 130 is developed and provided to control an image area of the image from vehicle camera 120. Ascertaining device 132 of control unit 130 is developed to ascertain positional information, which represents a road position of vehicle 100 relative to a road section driven by vehicle 100, using the vehicle sensor data of vehicle 100. Generating device 134 of control unit 130 is designed to generate a control signal for controlling the image area of the image from the vehicle camera, while making use of the positional information. Moreover, control unit 130 is designed to supply the control signal to an image area selection device, which is not shown in FIG. 1, and/or to a movable camera mounting device, which is likewise not depicted in FIG. 1.

FIG. 2 shows a schematic representation of a motorcycle 100 equipped with a camera system according to an exemplary embodiment of the present invention. Motorcycle 100, for instance, has an inertial sensor 102 and a speed sensor 104 as vehicle sensors. Motorcycle 100 is the vehicle from FIG. 1, for example. The camera system includes a vehicle camera 120 and a control unit 130 or a control device or apparatus for controlling an image area of an image from vehicle camera 120. Vehicle camera 120 is designed as a front-end camera by way of example, and the camera system is the camera system from FIG. 1, for instance. Control unit 130 is the control unit from FIG. 1.

In addition, the camera system has a camera mount 225 or a mounting device for mounting vehicle camera 120 on motorcycle 100. In a first variant of this exemplary embodiment, camera mount 225 or the mounting device is fixedly installed on the frame, and in a second variant of this exemplary embodiment, it can move. In addition, for instance, motorcycle 100 includes a device 240 for utilizing image data or the image from vehicle camera 120. As an alternative, it is also possible to provide a plurality of devices 240 for utilizing image data or the image from vehicle camera 120. Object detection systems, cockpit displays and the like are examples of devices 240.

Control unit 130 is designed to receive or read in sensor data from inertial sensor 102 and from speed sensor 104, as well as image data from vehicle camera 120. In addition, control unit 130 is developed to supply or make available to device 240 image data of an image having a controlled image area. Also, in the first variant of this exemplary embodiment, control unit 130 is designed to supply a control signal generated by control unit 130 to an image area selection device of the camera system and to output it to camera mount 225 or the mounting device in the second variant of this exemplary embodiment. Two variants are consequently possible for a method of operating control unit 130 or the control unit and the camera system.

The first variant pertains to a fixed installation of vehicle camera 120 and to image processing in control unit 130 or the control device. Vehicle camera 120 is an optical camera, which is equipped with a wide angle lens and fixedly mounted on motorcycle 100. Camera mount 225 or the mounting device is unable to move. Images detected or recorded by vehicle camera 120 are transmitted to control unit 130. Using the sensor data from inertial sensor 102 and speed sensor 104, control unit 130 transforms the images or the image data in such a way that an image area is selected or controlled as a function of the control signal, so that the images or the image data are largely decoupled from an ego motion of motorcycle 100 and image a region of a further trajectory of motorcycle 100.

The second variant pertains to the scenario in which camera mount 225 or the mounting device is able to move and a field of view or an orientation of vehicle camera 120 is set or adjusted by control unit 130 as a function of the control signal, utilizing camera mount 225. Vehicle camera 120 is installed on motorcycle 100 with the aid of moving or movable camera mount 225, which allows the alignment of vehicle camera 120 to be controlled in all three rotary degrees of freedom, for instance, so that a control of an image area of the camera image is possible. Using the sensor data transmitted to control unit 130, control unit 130 generates the control signal, so that an optimal alignment of vehicle camera 120 is induced by an actuation of actuators of camera mount 225.

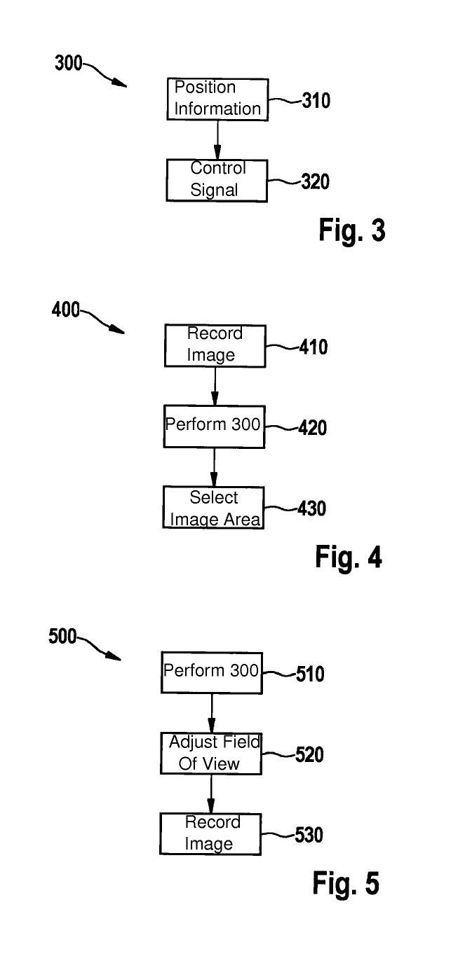

FIG. 3 shows a flow chart of a method 300 for controlling an image area of an image from a vehicle camera for a vehicle, in accordance with one exemplary embodiment of the present invention. Method 300 is able to be executed in conjunction with a camera system having a vehicle camera as well as a control unit for controlling an image area of an image from the vehicle camera. Method 300 can advantageously be carried out in connection with the camera system or the device or control unit from FIG. 1 or FIG. 2. The device or devices from FIG. 1 or FIG. 2 may be developed to carry out the steps of method 300. Method 300 includes a step 310 for ascertaining positional information, which represents a road position of the vehicle relative to a road section on which the vehicle is traveling, using vehicle sensor data of the vehicle. In addition, method 300 includes a step 320 of generating a control signal for controlling the image area of the image from the vehicle camera. Step 320 of generating utilizes the positional information.

FIG. 4 shows a flow chart of a method 400 for providing an image from a vehicle camera according to one exemplary embodiment of the present invention. Method 400 is able to be executed in conjunction with a camera system equipped with a vehicle camera as well as a control unit for controlling an image area of an image from the vehicle camera. Method 400 features a step 410 for recording an image with the aid of the vehicle camera. Method 400 also includes a step 420 of performing the steps of the method from FIG. 3. As a result, step 420 of performing includes partial ascertaining and generating steps. In addition, to provide the image, method 400 has a step 430 of selecting an image area of the image recorded with the aid of the vehicle camera, using the control signal generated in step 420. In other word, following step 410 of recording and prior to step 430 of selecting, method 400 also includes the steps of the method from FIG. 3. Method 400 for image recording can advantageously be carried out in conjunction with the camera system or the device or control unit from FIG. 1 or FIG. 2. Moreover, method 400 for image recording is advantageously able to be implemented in conjunction with the method for controlling from FIG. 3.

FIG. 5 shows a flow chart of a method 400 for providing an image from a vehicle camera according to a further exemplary embodiment of the present invention. Method 500 is able to be executed in conjunction with a vehicle camera as well as a control unit for controlling an image area of an image from the vehicle camera. Method 500 includes a step 510 of performing the steps of the method from FIG. 3. As a result, step 510 of performing includes partial steps of the ascertaining and generating. In addition, method 500 has a step 520 for adjusting a field of view of the vehicle camera, using the control signal generated in step 510. Moreover, method 500 includes a step 530 for recording an image with the aid of the vehicle camera in order to provide the image. In other words, prior to step 520 of adjusting, method 500 also includes the steps of the method from FIG. 3. Method 500 for image recording can advantageously be carried out in conjunction with the camera system or the device or control unit from FIG. 1 or FIG. 2. Moreover, method 500 for image recording is advantageously able to be implemented in conjunction with the method for controlling from FIG. 3.

The exemplary embodiments described and shown in the figures have been selected merely as examples. Different exemplary embodiments are combinable with one another, either completely or with regard to individual features. An exemplary embodiment may also be supplemented by features from another exemplary embodiment. Furthermore, method steps may be carried out repeatedly and may also be performed in a sequence other than the one described.

1.-10. (canceled)

11. A method for controlling an image area of an image from a vehicle camera for a motorized two-wheeled vehicle, the method comprising:
ascertaining positional information that represents a road position of the two-wheeled vehicle relative to a road section on which the vehicle is traveling, the ascertaining being carried out using vehicle sensor data of the vehicle; and
generating a control signal for controlling the image area of the image from the vehicle camera, the generating using the positional information.

12. The method as recited in claim 11, wherein in the step of ascertaining, an angle of inclination of the two-wheeled vehicle relative to the road section is ascertained as the positional information, with the aid of inertial sensor data of the vehicle.

13. The method as recited in claim 11, wherein in the step of ascertaining, a trajectory of the two-wheeled vehicle relative to the road section is ascertained as the positional information, with the aid of inertial sensor data and further vehicle sensor data for inferring a driven curve radius of the two-wheeled vehicle.

14. The method as recited in claim 11, wherein in the step of generating, the control signal includes an image compensation parameter for selecting the image area of the image, recorded with the aid of the vehicle camera, as a function of the positional information, in order to control the image area of the image.

15. The method as recited in claim 11, wherein in the step of generating, the control signal includes a camera compensation parameter for adjusting a field of view of the vehicle camera as a function of the positional information for a recording of the image, in order to control the image area of the image.

16. A device for controlling an image area of an image from a vehicle camera for a motorized two-wheeled vehicle, comprising:
a device for ascertaining positional information, which represents a road position of the two-wheeled vehicle relative to a road section on which the two-wheeled vehicle is traveling, using vehicle sensor data of the vehicle; and
a device for generating a control signal for controlling the image area of the image from the vehicle camera, the generating utilizing the positional information.

17. A camera system for a motorized two-wheeled vehicle, comprising:
a vehicle camera; and
a device for controlling an image area of an image from the vehicle camera for the motorized two-wheeled vehicle, the device including:
a device for ascertaining positional information, which represents a road position of the two-wheeled vehicle relative to a road section on which the two-wheeled vehicle is traveling, using vehicle sensor data of the vehicle, and
a device for generating a control signal for controlling the image area of the image from the vehicle camera, the generating utilizing the positional information.

18. The camera system as recited in claim 17, wherein:
the vehicle camera includes a wide angle lens, and
the control signal includes an image compensation parameter for selecting the image area of the image recorded with the aid of the vehicle camera as a function of the positional information, in order to control the image area of the image.

19. The camera system as recited in claim 17, further comprising:
a mounting device for a swivel-type mounting of the vehicle camera on the two-wheeled vehicle, wherein the control signal includes a camera compensation parameter for adjusting a field of view of the vehicle camera for recording the image as a function of the positional information with the aid of the mounting device, in order to control the image area of the image.

20. A computer program product having program code that when executed on a device carries out a method for controlling an image area of an image from a vehicle camera for a motorized two-wheeled vehicle, the method comprising:
ascertaining positional information that represents a road position of the two-wheeled vehicle relative to a road section on which the vehicle is traveling, the ascertaining being carried out using vehicle sensor data of the vehicle; and
generating a control signal for controlling the image area of the image from the vehicle camera, the generating using the positional information.
